(19) United States
(12) Patent Application Publication
(10) Pub. No.: US 2012/0098659 A1
(43) Pub. Date: Apr. 26, 2012

(54) Global Location System

(76) Inventor: Francisco Gomez, San Jose, CA (US)

(21) Appl. No.: 13/279,225

(22) Filed: Oct. 21, 2011

Related U.S. Application Data
(60) Provisional application No. 61/455,499, filed on Oct. 21, 2010.

(51) Int. Cl. G08B 1/08

(52) U.S. Cl. 340/539.32

(57) ABSTRACT

Embodiments of the present invention allow a user to locate lost items on a global basis without the need for a paired transmitter device. The missing item may be located using a call in phone number, SMS message, or through a web-based or mobile device application. The missing item (or item subject to being lost) is affixed with a light or sound emitting element that receives a locator signal triggered by a call to the aforementioned phone number, SMS message, or web/mobile instruction.

### CROSS-REFERENCE TO RELATED APPLICATIONS

The present application claims the priority benefit of U.S. provisional application No. 61/455,499 filed Oct. 21, 2010, the disclosure of which is incorporated herein by reference.

### BACKGROUND OF THE INVENTION

1. Field of the Invention

The present invention generally relates to the remote location of objects. More specifically, the present invention relates to locating items that have been misplaced or lost be it locally or anywhere around the globe.

2. Description of the Related Art

Almost every person who owns a car or a television has experienced the frustration of having lost their car keys or television remote control. The most common solution to this all too common phenomenon involves affixing a light or sound emitting element to the key ring or remote control. The light or sound emitting element is activated by a signal transmitted from a remote transmitter. Upon emission of the light or sound, the person is directed to the exact location of the missing item.

Paired locator systems like those described above are lacking for any number of reasons. Paired locator systems first require a user to have a remote transmitter device in their possession in order to emit the transmitter the locator signal. If the user does not have the transmitter in their possession, the user cannot activate the light or sound emitting element. Remote transmitter devices also tend to be as small as the keys or remote control that need to be located and, as a result, are just as easily lost.

Remote transmitter devices also tend to have relatively low power, which corresponds to a limited transmission range. If the missing keys or remote are not in nearby proximity, then the locator signal may not be able to reach the light or sound emitting element that is affixed to the car keys or remote control. A user of the remote transmitter may also habitually press the ‘transmission’ button out of nervous habit, which reduces the battery power of remote transmitter device to the point where the transmitter device is no longer able to transmit the locator signal. These transmitter devices typically use unusual battery sizes that may be difficult or inconvenient to find in the event a replacement is needed.

There is a need in the art for a system that locates lost items on a global basis without the need for a paired transmitter device.

### SUMMARY OF THE CLAIMED INVENTION

An embodiment of the claims invention includes a system for location of objects physically remote from one another. The system includes an object affixed to an emitter device, a service provider, and a transmitter. The service provider receives an identification number that is paired with the emitter device. The transmitter broadcasts a signal following the receipt of an identification number by the service provider. The emitter device is activated following receipt of the signal.

### BRIEF DESCRIPTION OF THE DRAWINGS

FIG. 1 illustrates a series of exemplary light or sound emitting elements that may be affixed to a set of keys, a remote control, or other device subject to being misplaced.

FIG. 2 illustrates a system for activating a light or sound emitting element like those described in FIG. 1.

### DETAILED DESCRIPTION

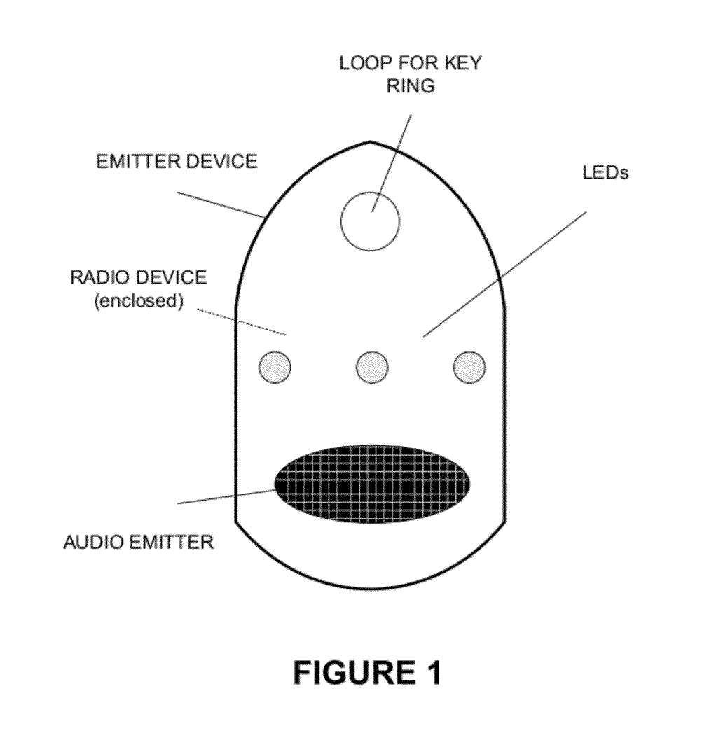

FIG. 1 illustrates an exemplary light or sound emitting elements that may be affixed to a set of keys, a remote control, or other device subject to being misplaced. Any number of form factors may be used depending on a particular object to which the emitter is to be affixed. The affixed emitter may be permanently coupled or removable. The emitter may be affixed using an adhesive, a magnet, which may include an adhesive backing, Velcro that has an adhesive backing, or other known means of coupling. The emitter may also be a standalone object that is included on a key ring like a key FOB.

The light or sound emitting elements of FIG. 1 operate using basic principles of radio transmission and reception. The light or sound emitting element includes or is coupled to a radio that receives transmitted radio waves from an outside source, converts energy transmitted via radio wave into an electrical impulse, which in turn activates the likes of a light emitting diode or audio transducer coupled to the radio and included in the emitter device. The radio receiver at the light or sound emitting element recognizes certain electromagnetic signals and not others in order to avoid emitting light or sound when a user not associated with the light or sound element activates the element. The light or sound emitting element may operate using paging technology as is known to one of ordinary skill in the art.

Locator signals may be transmitted using the likes of the Telocator Alphanumeric Input Protocol, which operates in conjunction with a paging network thereby lessening delays between the time of transmission of the location request and the activation of an LED or audio transducer at the element affixed to the keys or remote. Other transmission protocols include TAP, FLEX, ReFLEX, POCSAG, Golay, ERMES and NTT. Older protocols may similarly be used including two-tone and ⅚-tone.

In one embodiment of the present invention, the light or sound emitting element receives location requests using the FLEX protocol in the 900 MHz band. A transmitter broadcasting a location request may radiate at 1000 watts of effective power. Other radio bands may used, including the 400 MHz band, the VHF band, and the FM commercial broadcast band (88-108 MHz). Other paging protocols used in the VHF, 400 MHz UHF, and 900 MHz bands include POCSAG and ERMES.

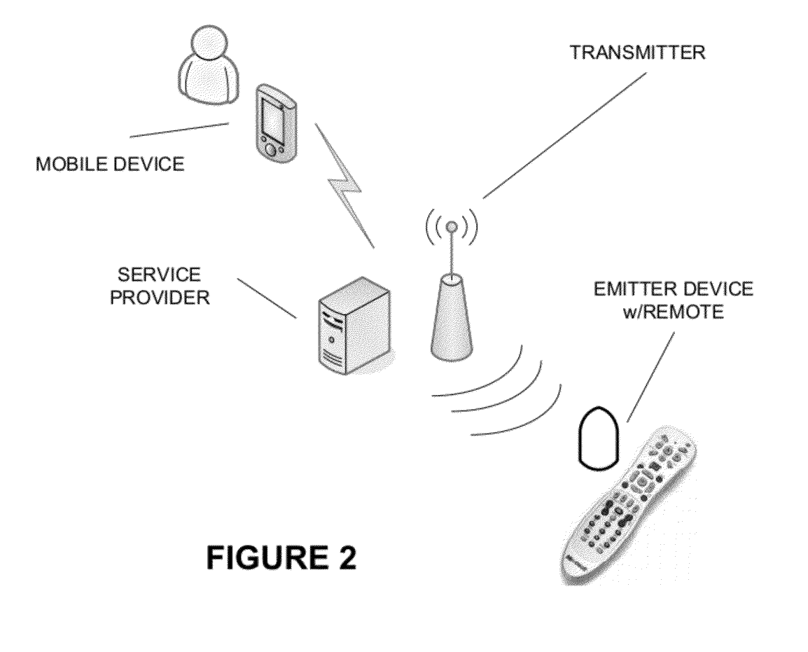

Satellite based transmissions may be utilized to better facilitate the global nature of certain embodiments of the present invention. World-wide coverage may be offered in such an embodiment. Location signals may be sent only to pre-selected delivery areas, which can be set on a web-based interface as further described in the context of FIG. 2 below.

FIG. 2 illustrates a system for activating a light or sound emitting element like those described in FIG. 1. A user seeking to locate a set of keys, a remote control, or other device that has a light or sound emitting element like those of FIG. 1 affixed thereto dials a phone number associated with the location network. This number may be operated by a particular service provider. Upon the service provider answering the call, the user may provide an identification number associated with a particular light or sound emitting element. The call may be answered by an actual operator or by an automated software program operating on a server device.

The software is stored in memory and is executing by processing components to effectuate the instructions embodied in the software. The software may execute to prompt the dialer to enter the identification number and access a database storing information that pairs the identification number to a light or sound emitting element. In order to prevent unauthorized persons from seeking to locate an object paired to the light or sound emitting element, a password or PIN number might be requested. Entry of the correct PIN number may be required before the server or the manual operator begins the actual location operation. Information matching the PIN or password and identification number may also be stored in the database.

The identification number is processed by the service provider to broadcast a location signal. This location signal may operate using any of the protocols described in the context of FIG. 1. The a light or sound emitting element then receives the location signal and activates an LED or audio transducer to alert the user as to the location of the keys, remote control, or other device. The location signal may be transmitted by a transmitter device coupled to or including hardware, software, or a combination thereof. The location signal may also be activated by a human operator.

The system of FIG. 2 may also operate using the likes of the short message system (SMS). A user may text a predetermined number and provide a short code associated with a particular light or sound emitting element. The SMS message may be sent directly from an SMS enabled mobile device, but also through a web-based interface that allows for translation of information provided through the interface into an SMS message for eventual transmission.

In a still further embodiment of FIG. 2, a user may allow for transmission of the location code using a smart phone executing an ‘application’ associated with locating missing items. Such a system may operate using the likes of the EDGE Network or a GPRS network and Internet Protocol. Such an application may allow for a single device to provide instructions to a number of light or sound emitting elements, at a certain time, or to trigger a particular light pattern or sound emission at the element.

The aforementioned embodiments are exemplary. No limitation should be implied by the aforementioned description, which is meant to include various alternative embodiments. The only limitations of the present invention should suggested by the express limitations of the claims, which are otherwise entitled to their equivalents.

What is claimed is:

1. A system for location of objects physically remote from one another, the system including:
an object affixed to an emitter device;
a service provider that receives an identification number paired with the emitter device; and
a transmitter that broadcasts a signal following the receipt of an identification number by the service provider, wherein the emitter device is activated following receipt of the signal.

2. The system of claim 1, wherein the object is a set of keys.

3. The system of claim 1, wherein the object is a remote control.

4. The system of claim 1, wherein the emitter device is coupled to a radio that receives radio waves that are converted into an electrical impulse that activates a light emitting diode in the emitter device, the light emitting diode emitting light.

5. The system of claim 1, wherein the emitter device is coupled to a radio that receives radio waves that are converted into an electrical impulse that activates an audio transducer in the emitter device, the audio transducer emitting sound.

6. The system of claim 1, wherein the emitter device is coupled to a radio that receives radio waves that are converted into an electrical impulse that activates a light emitting diode in the emitter device and an audio transducer, the light emitting diode and audio transducer respectively emitting light and sound.

7. The system of claim 1, wherein the service provider also receives a PIN number or password that must match the identification number prior to the signal being broadcasted.

8. The system of claim 1, wherein the emitter device and transmitter operate using a paging network.

9. The system of claim 1, wherein the emitter device and transmitter operate using a paging network.

10. The system of claim 1, wherein the emitter device and transmitter operate using an SMS network.

11. The system of claim 1, wherein the emitter device and transmitter operate using a satellite network.

12. The system of claim 1, wherein the emitter device and transmitter operate using a GPRS network.

13. The system of claim 1, wherein the service provider receives the identification number from a mobile device.

14. The system of claim 13, wherein the identification number is an SMS message.

15. The system of claim 14, wherein the mobile device includes a web-based interface that translates information into the SMS message.

16. The system of claim 13, wherein the mobile device is a smart phone that executes an application that communicates with the service provider.

17. The system of claim 16, wherein the application allows for communication with a plurality of emitter devices.

18. The system of claim 17, wherein the application allows for location instructions to be provided at a certain time.

19. The system of claim 17, wherein the application allows for location instructions to trigger a particular light pattern at the emitter device.

20. The system of claim 17, wherein the application allows for location instructions to trigger a particular sound emission at the emitter device.
